(19) United States
(12) Patent Application Publication
(10) Pub. No.: US 2018/0056977 A1
(43) Pub. Date: Mar. 1, 2018

(54) VEHICLE INCLUDING ELECTRIC MOTOR AND METHOD OF DISPLAYING ENERGY GENERATED VIA REGENERATIVE BRAKING

(71) Applicant: Hyundai Motor Company, Seoul (KR)

(72) Inventor: Jin Hyung Lee, Seoul (KR)

(21) Appl. No.: 15/363,019

(22) Filed: Nov. 29, 2016

(30) Foreign Application Priority Data
Sep. 1, 2016 (KR) 10-2016-0112623

(51) Int. Cl. B60W 20/14; B60L 11/18; B60L 7/10; B60W 50/14

(52) U.S. Cl. CPC B60W 20/14; B60W 2050/146; B60L 7/10; B60W 50/14; B60W 2710/244; B60W 2560/02; B60W 2510/242; B60L 2240/54; B60Y 2300/18125; B60Y 2300/91; B60Y 2400/112; Y10S 903/907; B60Y 2400/92; B60L 2250/16; B60L 11/1861

(57) ABSTRACT

A display method is provided to effectively calculate energy generated from a motor and to notify a driver of information regarding the calculated energy during regenerative braking in a vehicle including the motor for generating driving force. The method includes monitoring battery voltage and current for an electric motor and determining whether regenerative braking is performed using the monitoring result. Additionally, the method includes accumulatively calculating a total amount of energy collected via regenerative braking during the regenerative braking and converting the calculated total amount of energy into an increased amount of distance to empty (DTE). The increased amount of the converted DTE is then output on a display for a driver.

### CROSS REFERENCE TO RELATED APPLICATION

This application claims the benefit of Korean Patent Application 10-2016-0112623, filed on Sep. 1, 2016, which is hereby incorporated by reference as if fully set forth herein.

### BACKGROUND

### Field of the Invention

The present invention relates to a vehicle including an electric motor and a method of displaying energy generated via regenerative braking, and more particularly, to a display method of effectively calculating energy generated from a motor and notifying a driver of information regarding the calculated energy during regenerative braking in a vehicle including the motor for generating driving force and a vehicle for performing the method.

### Discussion of the Related Art

In general, a hybrid electric vehicle (REV) refers to a vehicle that uses two power sources including an engine and an electric motor. An REV has excellent fuel efficiency and engine performance compared to a vehicle including only an internal combustion engine and is also advantageous for lowering emissions and, thus, has been actively developed recently. Along with an REV, an electric vehicle (EV) driven using a driving force of an electric motor has been developed as an eco-friendly vehicle.

Such a plug-in HEY (PHEV) and an EV are the same in terms of including a motor for generating a driving force and, thus, regenerative braking is performed through the motor. Particularly, regenerative braking refers to an electric braking method of operating an electric motor as a generator and converting kinetic energy into electric energy to collect the electric energy to exert braking force and is also referred to as power regenerative brake.

However, when regenerative braking is performed, when a driver is capable of intuitively recognizing an amount of collected energy through regenerative braking, regenerative braking is guided to be more actively used than friction brake and, thus fuel efficiency is enhanced. However, current vehicles have not been developed to intuitively notify a driver of energy collected via regenerative braking.

### SUMMARY

Accordingly, the present invention is directed to a vehicle including an electric motor and a method of displaying energy generated via regenerative braking that substantially obviate one or more problems due to limitations and disadvantages of the related art. An object of the present invention is to provide a method of more intuitively notifying a driver of a regenerative braking in a vehicle including an electric motor and a vehicle for performing the method.

Another object of the present invention is to provide a method of calculating a regenerative braking amount and visually displaying the calculated regenerative braking amount to allow a driver to intuitively understand a regenerative braking amount and a vehicle for performing the method.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of displaying a regenerative braking amount of a vehicle may include accumulatively calculating a total amount of energy collected via regenerative braking during the regenerative braking, converting the calculated total amount of energy into an increased amount of distance to empty (DTE), and visually outputting an increased amount of the converted DTE.

In another aspect of the present invention, a method of displaying a regenerative braking amount of a vehicle may include accumulatively calculating a product of battery voltage and current within a predetermined period time when the product is a negative value, by a first controller, multiplying the value accumulatively calculated by the first controller by distance to empty (DTE)-calculated fuel efficiency, and transmitting, by a second controller, a result of the multiplying to a third controller to output the result.

In another aspect of the present invention, a vehicle may include an electric motor, a first controller configured to accumulatively calculate a total amount of energy collected via regenerative braking and convert the calculated total amount of energy into an increased amount of distance to empty (DTE) upon determining that the regenerative braking is performed using a monitoring result of battery voltage and current for the electric motor, and a second controller configured to visually output or display an increased amount of the DTE converted by the first controller.

In another aspect of the present invention, a vehicle may include a first controller configured to accumulatively calculate a product of battery voltage and current within a predetermined period of time when the product is a negative value and multiplying the accumulatively calculated value by distance to empty (DTE)-calculated fuel efficiency to calculate an increased amount of the DTE, and a second controller configured to visually output the increased amount of the DTE.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate exemplary embodiment(s) of the invention and together with the description serve to explain the principle of the invention. In the drawings:

FIG. 1 is a block diagram illustrating an example of a structure of a vehicle according to an exemplary embodiment of the present invention;

FIG. 2 is a flowchart of an example of a procedure of displaying a regenerative braking amount according to an exemplary embodiment of the present invention; and

FIGS. 3A to 3D are examples of an embodiment of displaying a regenerative braking amount according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Reference will now be made in detail to the exemplary embodiments of the present invention, examples of which are illustrated in the accompanying drawings. In the drawings, the same elements are denoted by the same reference numerals, and a repeated explanation thereof will not be given. The suffixes “module” and “unit” of elements herein are used for convenience of description and thus can be used interchangeably and do not have any distinguishable meanings or functions.

In the description of the present invention, certain detailed explanations of the related art are omitted when it is deemed that they may unnecessarily obscure the essence of the invention. The features of the present invention will be more clearly understood from the accompanying drawings and should not be limited by the accompanying drawings and it is to be appreciated that all changes, equivalents, and substitutes that do not depart from the spirit and technical scope of the present invention are encompassed in the present invention.

According to an exemplary embodiment of the present invention, to more intuitively notify a driver of an amount of collected energy during regenerative braking, an energy amount may be converted and displayed into a distance to empty (DTE). In particular, according to an exemplary embodiment of the present invention, while one-time regenerative braking is performed during entrance into regenerative brake from discharge driving (i.e., a driving situation in which a battery is consumed to generate driving force via a motor), an accumulatively increased amount of DTE may be calculated and displayed.

According to an exemplary embodiment of the present invention, an accumulatively increased amount of DTE may be reset for each one-time regenerative braking and a total accumulatively increased amount of DTE based on an entire regenerative braking amount of a current driving cycle may also be displayed along with the one-time regenerative braking amount. In addition, according to an exemplary embodiment of the present invention, the DTE accumulatively increased amount may be displayed on a cluster or may also be displayed on a display of a head unit. The above-described embodiments are merely exemplary and, thus, a separate display for displaying the DTE accumulatively increased amount may be provided.

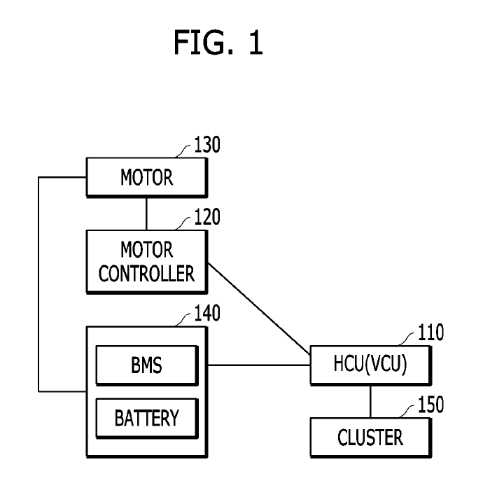

First, a structure of a vehicle to which exemplary embodiments of the present invention are applicable will be described with reference to FIG. 1. FIG. 1 is a block diagram illustrating an example of a structure of a vehicle according to an exemplary embodiment of the present invention. Components illustrated in FIG. 1 are exemplary and, thus, it would be obvious to one of ordinary skill in the art that a vehicle to which the present invention is actually applied may include greater or fewer components than in FIG. 1.

Referring to FIG. 1, the vehicle according to the exemplary embodiment of the present invention may include a higher controller 110 (e.g., an upper controller) configured to execute overall operations of controllers (e.g., lower or subordinate controllers) associated with driving based on a type (EV/PHEV) of a driving system, a motor controller 120 configured to operate a motor 130 based on a torque command of the higher controller 110, a power module 140 configured to supply power to the motor 130 or collect energy generated via regenerative braking, and a cluster controller 150 configured to display a calculated regenerative braking amount. The cluster controller 150 may be substituted with another controller (e.g., a head unit) configured to operate vehicle components including a display.

Particularly, the higher controller 110 may be referred to as a hybrid control unit (HCU) for a hybrid vehicle and may be referred to as a vehicle control unit (VCU) for an electric vehicle. In other words, the higher controller 110 is not necessarily limited to these terms. The power module 140 may include a battery management system (BMS) and a battery operated by the BMS. The BMS may be configured to obtain state information of state of charge (SOC), voltage, current, and temperature from a battery using various sensors, provide the information to another controller, and manage input and output power of the battery. In the present exemplary embodiment, the BMS may be configured to detect whether regenerative braking is performed using voltage and current input/output to/from the motor 130, calculate a collected energy amount via the corresponding regenerative braking and an increased amount of DTE, corresponding to the collected energy amount, when the regenerative braking is performed, and transmit the calculated collected energy amount and increased amount of DTE to the higher controller 110. The higher controller 110 may then be configured to transmit the increased amount of DTE to a controller of a display.

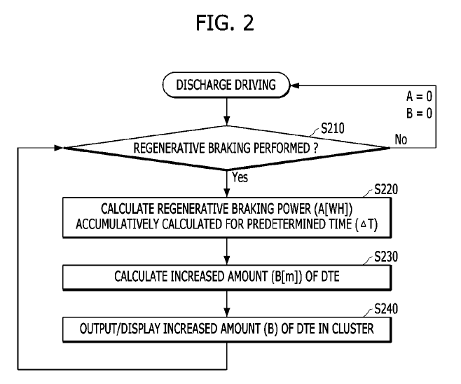

Based on the aforementioned vehicle structure, a procedure of displaying the regenerative braking amount will be described with reference to FIG. 2. FIG. 2 is a flowchart of an example of a procedure of displaying a regenerative braking amount according to an exemplary embodiment of the present invention. Referring to FIG. 2, when discharge driving is performed, a BMS may be configured to monitor battery current and voltage to determine whether regenerative braking is performed (S210).

Whether regenerative braking is performed may be determined according to Equation 1 below.

Battery Current×Voltage<0?

According to Equation 1 above, a product of battery current and voltage is a positive value during discharging and is a negative value during charging and, thus, when the product of the battery current and voltage is a negative value, the BMS may be configured to determine that regenerative braking is being performed.

When regenerative braking is performed, a regenerative braking power value may be accumulatively calculated within a predetermined period of time (S220). An accumulative value of the regenerative braking power value may be calculated according to Equation 2 below.

A=A−(Battery Current×Voltage)Δt

wherein, Δt refers to a time unit in which calculation is performed and A is an accumulative value of regenerative braking power value. A unit of A may be watt-hour (Wh) but is not limited thereto. Since the product of the battery current and voltage is a negative value during regenerative braking, a value A may be accumulatively increased for each Δt.

Then, the accumulative value of the regenerative braking power value may be converted into an increased amount of DTE (S230). The increased amount of DTE may be calculated according to Equation 3 below.

B=A×DTE-Calculated Fuel Efficiency

In Equation 3, B refers to an increased amount of DTE and the DTE-calculated fuel efficiency may be a preset officially-approved fuel efficiency or average fuel efficiency during a predetermined driving time period based on settings. A unit of B may be meters (m) but it would be obvious to one of ordinary skill in the art that the unit may be changed and converted into feet (ft), yards (yd), or the like according to regional metrological standards.

The increased amount of DTE may then be displayed through a display such as a cluster (S240). Accordingly, the BMS may be configured to transmit the calculated increased amount of DTE to the higher controller 110 and the higher controller 110 may be configured to re-transmit the increased amount of DTE to a controller (e.g., a cluster controller) configured to operate components of a vehicle including a display. When the increased amount of DTE is completely transmitted and displayed, A and B (e.g., the variables in Equation 2 and Equation 3 above) may be reset to 0 to calculate a collected energy amount when next regenerative braking occurs.

The aforementioned procedure may be performed only once during one-time continuous regenerative braking or may be performed every Δt. In other words, when one-time regenerative braking is completed (e.g., a product of battery voltage and current reaches 0 or a positive value), a total increased amount of DTE according to energy collected via the corresponding regenerative braking may be transmitted to a higher controller once or a total increased amount of DTE, calculated every Δt up to a corresponding time until one-time regenerative braking is completed, may be transmitted to the higher controller a plurality of times.

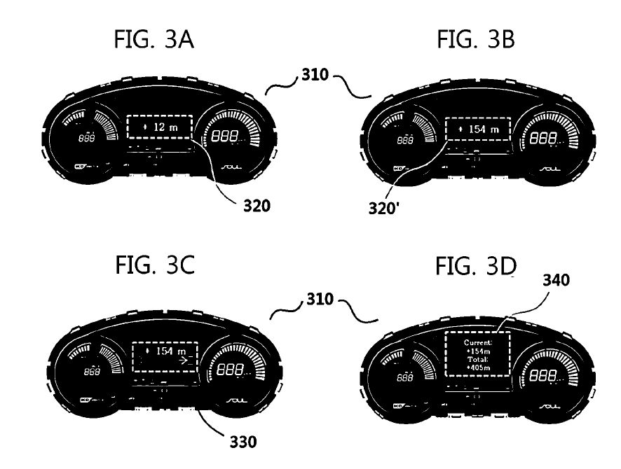

Hereinafter, an exemplary embodiment of displaying an increased amount of DTE will be described with reference to FIGS. 3A to 3D. FIGS. 3A to 3D are examples of displaying a regenerative braking amount according to an exemplary embodiment of the present invention. In FIGS. 3A to 3D, a display configured to display an increased amount of DTE may be a cluster 310 and an increased amount of DTE, corresponding to energy collected via current regenerative braking, may be assumed to be calculated as about 154 meters.

Referring to FIG. 3A, as regenerative braking begins, an increased amount of DTE 320 displayed in the cluster 310 begins to increase from 0 and continues to be adjust up to a final increased amount of DTE 320′, as illustrated in FIG. 3B. In particular, as illustrated in FIG. 3C, an increased amount of DTE may be displayed by filling a progress bar 330 together with a number and, as illustrated in FIG. 3D, a total accumulatively increased amount of DTE for each driving cycle via current regenerative braking may also be displayed (340) together.

Although the aforementioned exemplary embodiments of the present invention describe a BMS configured to whether regenerative braking is performed, accumulatively calculate collected energy, and calculate an increased amount of DTE, this is merely an example and, thus, it would be obvious to one of ordinary skill in the art that the BMS may be configured to provide only voltage and current values and another controller (e.g., a higher controller or a separate dedicated controller for output of an increased amount of DTE) may be configured to perform various determination and calculation operations.

The aforementioned present invention can also be embodied as computer readable code stored on a non-transitory computer readable recording medium. The non-transitory computer readable recording medium is any data storage device capable of storing data which can be thereafter read by a computer. Examples of the non-transitory computer readable recording medium include a hard disk drive (HDD), a solid state drive (SSD), a silicon disc drive (SDD), read-only memory (ROM), random-access memory (RAM), CD-ROM, magnetic tapes, floppy disks, optical data storage devices, carrier wave (e.g., transmission via the Internet), etc.

According to at least one exemplary embodiment of the present invention, the vehicle configured as described above may more intuitively notify a driver of a regenerative braking amount. In particular, a regenerative braking amount may be converted into an increased amount of DTE and may be displayed to allow a driver to intuitively detect a regenerative braking amount to provide fuel efficient driving through the regenerative braking amount.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings. It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of displaying a regenerative braking amount of a vehicle, comprising:
accumulatively calculating, by a controller, a total amount of energy collected via regenerative braking during the regenerative braking;
converting, by the controller, the calculated total amount of energy into an increased amount of distance to empty (DTE); and
outputting, by the controller, an increased amount of the converted DTE on a display.

2. The method according to claim 1, wherein the regenerative braking is determined to be performed when a product of battery voltage and current is a negative value.

3. The method according to claim 1, wherein the total amount of energy collected via regenerative breaking is accumulatively calculated in a predetermined time interval during the regenerative braking.

4. The method according to claim 1, wherein the increased amount of distance to empty is converted by multiplying the calculated total amount of energy by DTE-calculated fuel efficiency.

5. The method according to claim 4, wherein the DTE-calculated fuel efficiency includes preset fuel efficiency or average fuel efficiency during a predetermined time period.

6. The method according to claim 1, wherein the increased amount of the converted DTE is displayed in the form of change in a number or change in a figure size.

7. The method according to claim 1, wherein the total amount of energy collected via regenerative breaking is accumulatively calculated during one-time regenerative braking.

8. A vehicle, comprising:
an electric motor;
a first controller configured to accumulatively calculate a total amount of energy collected via regenerative braking and convert the calculated total amount of energy into an increased amount of distance to empty (DTE) in response to determining that the regenerative braking is performed using a monitoring result of battery voltage and current for the electric motor; and
a second controller configured to adjust an increased amount of the DTE converted by the first controller to be output on a display.

9. The vehicle according to claim 8, wherein the first controller is configured to determine that the regenerative braking is performed when a product of the battery voltage and current is a negative value.

10. The vehicle according to claim 8, wherein the first controller is configured to accumulatively calculate the total amount of energy collected in a predetermined time interval during the regenerative braking.

11. The vehicle according to claim 8, wherein the first controller is configured to accumulatively calculate the total amount of energy collected during one-time regenerative braking.

12. The vehicle according to claim 8, wherein the first controller is configured to convert an increased amount of DTE by multiplying the calculated total amount of energy by the DTE-calculated increased amount.

13. The vehicle according to claim 12, wherein the DTE-calculated fuel efficiency includes preset fuel efficiency or average fuel efficiency during a predetermined time period.

14. The vehicle according to claim 8, wherein the second controller is configured to operate a cluster or a display of a head unit to display the increased amount of DTE.

15. The vehicle according to claim 8, further comprising:
a third controller configured to receive the increased amount of DTE from the first controller and transmit the increased amount of DTE to the second controller.

16. The vehicle according to claim 15, wherein:
the first controller is a battery management system (BMS);
the second controller is a cluster controller configured to operate a display of a cluster within the vehicle; and
the third controller is a hybrid controller (HCU) or an electric vehicle controller (VCU).

17. A non-transitory computer readable medium containing program instructions executed by a controller for displaying a regenerative braking amount of a vehicle, the computer readable medium comprising:
program instructions that accumulatively calculate a total amount of energy collected via regenerative braking during the regenerative braking;
program instructions that convert the calculated total amount of energy into an increased amount of distance to empty (DTE); and
program instructions that output an increased amount of the converted DTE on a display.

18. The non-transitory computer readable medium of claim 17, wherein the regenerative braking is determined to be performed when a product of battery voltage and current is a negative value.

19. The non-transitory computer readable medium of claim 17, wherein the total amount of energy collected via regenerative breaking is accumulatively calculated in a predetermined time interval during the regenerative braking.

20. The non-transitory computer readable medium of claim 17, wherein the increased amount of distance to empty is converted by multiplying the calculated total amount of energy by DTE-calculated fuel efficiency.
